(19) United States
(12) Patent Application Publication
(10) Pub. No.: US 2019/0024611 A1
(43) Pub. Date: Jan. 24, 2019

(54) INTERNAL COMBUSTION ENGINE PROVIDED WITH A SEMI- AUTOMATIC CHOKE DEVICE

(71) Applicant: HUSQVARNA AB, Huskvarna (SE)

(72) Inventors: Tomas Wykman, Jönköping (SE); Anders Angrén, Huskvarna (SE)

(21) Appl. No.: 16/070,369

(22) PCT Filed: Jan. 25, 2016
(86) PCT No.: PCT/EP2016/051444

§ 371 Date: Jul. 16, 2018

(51) Int. Cl. F02M 1/08; F02M 1/02; F02N 3/02; F02B 75/02; F02B 63/02

(52) U.S. Cl. CPC F02M 1/08; F02M 1/02; F02N 3/02; F02B 2075/025; F02B 63/02; F02N 2200/022; F02B 75/02

(57) ABSTRACT

A starter system (400), for an internal combustion engine (200) including a carburetor (450) and a recoil starter (150), may include a sensor (420), a controller (430) and an actuator (440). The carburetor (450) may have at least a choke valve (322) for controlling a flow of a fresh air into a combustion chamber (232) of the engine (200) during engine start. The choke valve (322) may have a choke position and an open position and may be positioned into the choke position at engine start. The recoil starter (150) may start a rotation of an engine crankshaft causing a fuel supply to the combustion chamber (232) of the engine (200). The sensor (420) may be disposed to detect movement parameters associated with the engine (200) or crankshaft responsive to operation of the recoil starter (150). The controller (430) may be operably coupled to the sensor (420) to receive information indicative of the movement parameters and providing a control signal based on processed information providing an indication of an optimal condition for engine start. The actuator (440) may be configured to receive the control signal from the controller (430) and to initiate automatic repositioning of the choke valve (322) from the choke position to the open position based on receiving the control signal from the controller (430) responsive to the indication of the optimal condition for engine start.

### TECHNICAL FIELD

Example embodiments generally relate to hand held power equipment and, more particularly, relate to a semi-automatic starter assembly for an internal combustion engine of such equipment.

### BACKGROUND

Chainsaws are commonly used in both commercial and private settings to cut timber or perform other rigorous cutting operations. Because chainsaws are typically employed in outdoor environments, chainsaws are typically relatively robust hand held machines that are expected to start and operate in a wide range of environmental conditions. They can be powered by gasoline engines (e.g., two-stroke internal combustion engines) that operate to turn a chain around a bar at relatively high speeds. The chain includes cutting teeth that engage lumber or another medium in order to cut the medium as the teeth are passed over a surface of the medium at high speed.

Particularly in a commercial setting, operators may spend hours each day operating the chainsaw, and such operation may include multiple start and stop cycles. These start and stop cycles may, dependent upon how spaced apart they come from each other, be considered cold or warm starting conditions, which may have different impacts on the startability of the internal combustion engine of the chainsaw. Starting the internal combustion engine may be accomplished, at least in part, by controlling the air/fuel (A/F) ratio within relatively narrow limits by controlling operation of a fuel supply system that may employ, for example, a carburetor.

Starting a two-stroke internal combustion engine (which are employed not only in many other hand held outdoor power equipment devices in addition to chainsaws, but also in motorcycles and boats) in different environmental temperature ranges and with different internal temperatures typically requires different starting procedures related to operation of the carburetor. In particular, different procedures may be required for cold vs. warm starting conditions, and such procedures may further require the operator to know when and how to employ the choke valve of the carburetor. Moreover, there is typically not any (or a very limited) user interface provided to give the operator feedback on the starting procedure.

For very experienced users, the challenges of starting the two-stroke internal combustion engine may be familiar, and may be relatively easy to cope with. However, for less experienced users, difficulty in starting the engine can be a real problem. In either case, improving the startability of the engine while simplifying the starting process would certainly be a welcome change.

### BRIEF SUMMARY OF SOME EXAMPLES

Some example embodiments may provide for better control of choke valve positioning during the starting process. In this regard, for example, some embodiments may provide for a semi-automatic control of the positioning of the choke valve. In particular, the choke valve may be manually positioned initially, but may be automatically shifted to a normal (open/off) position after initial ignition is detected.

In one example embodiment, a starter system for an internal combustion engine is provided. The internal combustion engine includes a carburetor and a starter that might be of recoil type. The starter system may include a sensor, a controller and an actuator. The carburetor may have at least a choke valve for controlling a flow of a fresh air into a combustion chamber of the engine during engine start. The choke valve may have a choke position and an open position and may be positioned into a choke position at engine start. The recoil starter may start a rotation of an engine crankshaft causing a fuel supply to the combustion chamber of the engine. The sensor may be disposed to detect movement parameters associated with the engine or crankshaft responsive to operation of the recoil starter. The controller may be operably coupled to the sensor to receive information indicative of the movement parameters and providing a control signal based on processed information providing an indication of an optimal condition for engine start for an air and fuel ratio being optimal for an ignition and the engine start. The actuator may be configured to receive the control signal from the controller and to initiate automatic repositioning of the choke valve from the choke position to the open position based on receiving the control signal from the controller responsive to the indication of the optimal condition for engine start.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a perspective view of a chainsaw according to an example embodiment;

FIG. 2 illustrates a schematic view of a two-stroke internal combustion engine according to an example embodiment;

FIG. 3 illustrates a carburetor type fuel supply system in accordance with an example embodiment;

FIG. 4 illustrates a block diagram of various components of a semi-automatic starter assembly in accordance with an example embodiment; and

FIG. 5, which includes FIGS. 5A, 5B and 5C, shows various views of some of the components of a semi-automatic starter assembly as such components would appear in isolation if viewed from corresponding sides of the chainsaw in which the assembly is instantiated in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

As indicated above, some example embodiments may improve the startability of two-stroke internal combustion engines. In this regard, some embodiments may allow automatic repositioning of the choke valve after initial ignition is detected. In a typical case, initial ignition is detected by listening for a “pop” sound during one pull of the recoil starter. The choke valve is generally engaged during the initial pulls of the recoil starter until the “pop” is heard. This indication of initial ignition means that the choke valve can be shut off. The next pull (or one of the next couple pulls) of the recoil starter would then be expected to start the engine. However, if the operator is inexperienced and does not detect the “pop” sound and does not reposition the choke valve as a consequence of it, the engine may flood by fuel and starting may be precluded. This can lead to an operator frustration and prevent product satisfaction.

Some example embodiments may therefore improve startability by providing automatic repositioning of the choke valve after detection of conditions that correspond to initial ignition having occurred. This will prevent the inexperienced user from missing the indications of initial ignition and risking engine flooding. It also simplifies the starting procedure (since the manual repositioning of the choke valve is not needed) so that both experienced and inexperienced users can more easily and efficiently start two-stroke internal combustion engines for outdoor power equipment.

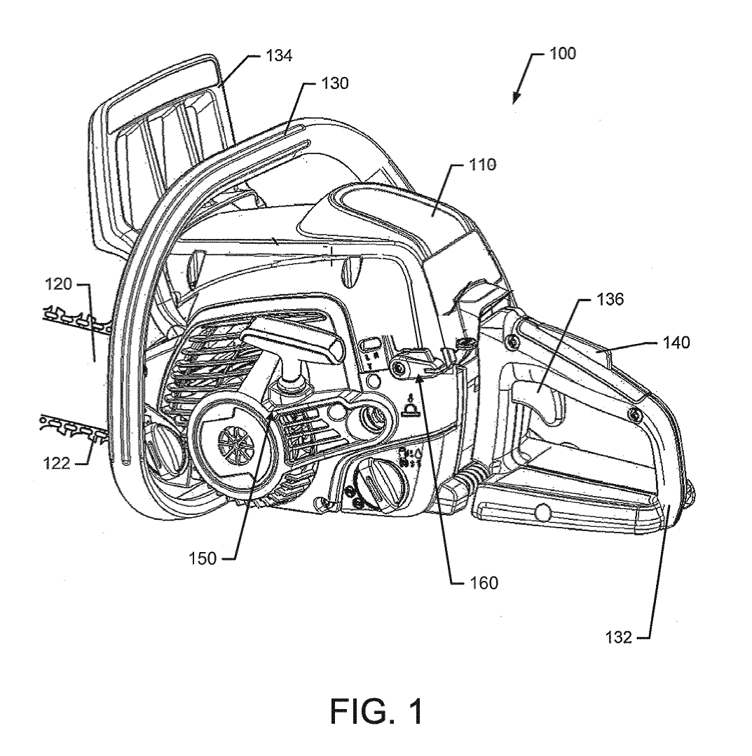

FIG. 1 illustrates a perspective view of a chainsaw 100 according to an example embodiment. It should be appreciated that the chainsaw 100 is merely one example of power equipment that includes a two-stroke internal combustion engine (or simply engine) that may benefit from a semi-automatic choke repositioning starting system of an example embodiment. Thus, example embodiments could also be practiced in connection with some other power equipment such as, but not limited to motor saws, trimmers, hedge trimmers, power cutters, brush cutters, blowers, etc., that may include working assemblies of different types including motorbikes and boats that are powered by two-stroke internal combustion engines.

As shown in FIG. 1, the chainsaw 100 may include a housing 110 inside which a power unit (e.g., the two-stroke internal combustion engine) is housed. The chainsaw 100 may further include a guide bar 120 that is attached to the housing 110 along one side thereof. A chain 122 may be driven around the guide bar 120 responsive to operation of the power unit in order to enable the chainsaw 100 to cut lumber or other materials. The guide bar 120 and the chain 122 may form the working assembly of the chainsaw 100.

The chainsaw 100 may include a front handle 130 and a rear handle 132. A chain brake and front hand guard 134 may be positioned forward of the front handle 130 to stop the movement of the chain 122 in the event of a kickback. In an example embodiment, the hand guard 134 may be tripped by rotating forward in response to contact with a portion of the arm (e.g., the hand/wrist) of the operator of the chainsaw 100. In some cases, the hand guard 134 may also be tripped in response to detection of inertial measurements indicative of a kickback.

The rear handle 132 may include a trigger 136 to facilitate operation of the power unit relative to turning the working assembly when the trigger 136 is actuated. In this regard, for example, when the trigger 136 is actuated (e.g., depressed), the rotating forces generated by the power unit may be coupled to the chain 122 either directly or indirectly. The term “trigger,” as used herein, should be understood to represent any actuator that is capable of being operated by a hand or finger of the user. Thus, the trigger 136 may represent a button, switch, or other such component that can be actuated by a hand or portion thereof. In some cases, the trigger 136 may be locked or inoperable until another actuator 140 is depressed to indicate presence of the operators hand firmly on the rear handle 132 so that the trigger 136 cannot be accidentally actuated.

The power unit may employ a clutch to provide operable coupling of the power unit to a sprocket that turns the chain 122. In some cases (e.g., for a two-stroke internal combustion engine), if the trigger 136 is released, the engine may idle and application of power from the power unit to turn the chain 122 may be stopped. The housing 110 may include a fuel tank for providing fuel to the power unit. The housing 110 may also include or at least partially define an oil reservoir, access to which may be provided to allow the operator to pour oil into the oil reservoir. The oil in the oil reservoir may be used to lubricate the chain 122 as the chain 122 is turned.

As can be appreciated from the description above, actuation of the trigger 136 may initiate movement of the chain 122 around the guide bar 120. For power units that employ two-stroke internal combustion engine, the engine may operate in an idle state after starting of the engine until the trigger 136 is pressed. The idle state may represent a condition during which the engine operates at a lower Revolution Per Minute (RPM) to sustain continuous operation of the engine and maintain the engine in a ready state to respond to actuation of the trigger 136. When the trigger 136 is pressed, the throttle valve within the carburetor of the two-stroke internal combustion engine may open to increase the flow of an air and fuel mixture within the engine and increase RPM and turn the chain 122 for cutting, e.g., via engagement of a clutch.

As discussed above, starting of the engine may be accomplished using a recoil starter 150. The recoil starter 150 is pulled by the operator and a cord that is wound about a recoil pulley is rotated in a first direction. The rotation of the recoil pulley is transferred to the crankshaft of the engine via a one-way coupling. Meanwhile, after the cord of the recoil starter 150 is released, a torsional recoil spring causes the cord to be retracted around the recoil pulley. This allows the recoil starter 150 to be poised for another pull, if necessary. Additional pulls are repeated until the engine starts. The one-way coupling allows the crankshaft to turn freely relative to the recoil pulley after the engine starts. The operator typically manually positions an operable member 160 (e.g., a choke lever) to adjust the position of a choke valve in the carburetor during the starting procedure. The operator manually closes the choke valve using the operable member 160 and then manually repositions the operable member 160 again at the appropriate time for the starting procedure (e.g., after the “pop” is occurred).

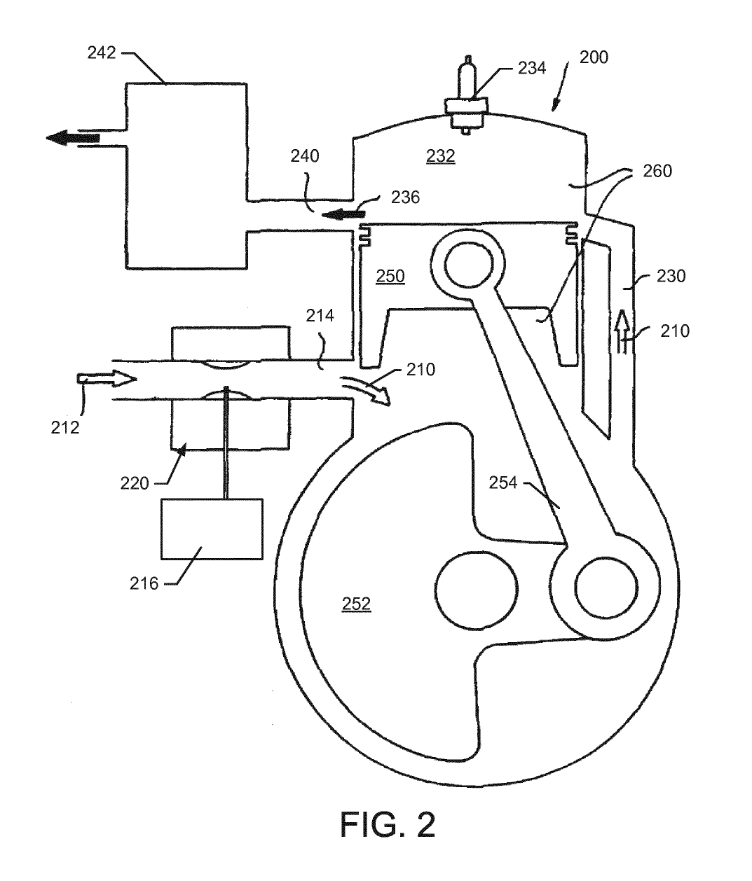

FIG. 2 illustrates a schematic view of a two-stroke internal combustion engine 200. However, example embodiments could also be practiced in connection with internal combustion engines of different types (e.g., four-stroke engines). The engine 200 of FIG. 2 is crank case scavenged in which, for example, a mixture 210 of air 212 and fuel from a fuel tank 216 that is provided from a fuel supply system 220 (e.g., a carburetor or low pressure fuel injection system) is drawn to the engine crank house through an intake port 214. From the crank house, the mixture 210 is carried through one or several scavenging passages 230 up to an engine combustion chamber 232. The engine combustion chamber 232 is provided with a spark plug 234 that ignites the compressed air-fuel mixture. Exhausts 236 may exit through an exhaust port 240 and through a silencer 242.

The engine 200 may also include a piston 250 that is attached to a crank portion 252 equipped with a counter weight via a connecting rod 254. In FIG. 2, the piston 250 assumes an intermediate position in which flow is possible both through the intake port 214, the exhaust port 240 and through the scavenging passage 230. The mouth of intake passage into the cylinder 260 may be referred to as the intake port 214. Accordingly, the intake passage may be closed by the piston 250. By opening and closing the intake passage, varying flow speeds and pressures may be created inside the passage. These variations largely affect the amount of fuel supplied when the fuel supply system 220 is a carburetor.

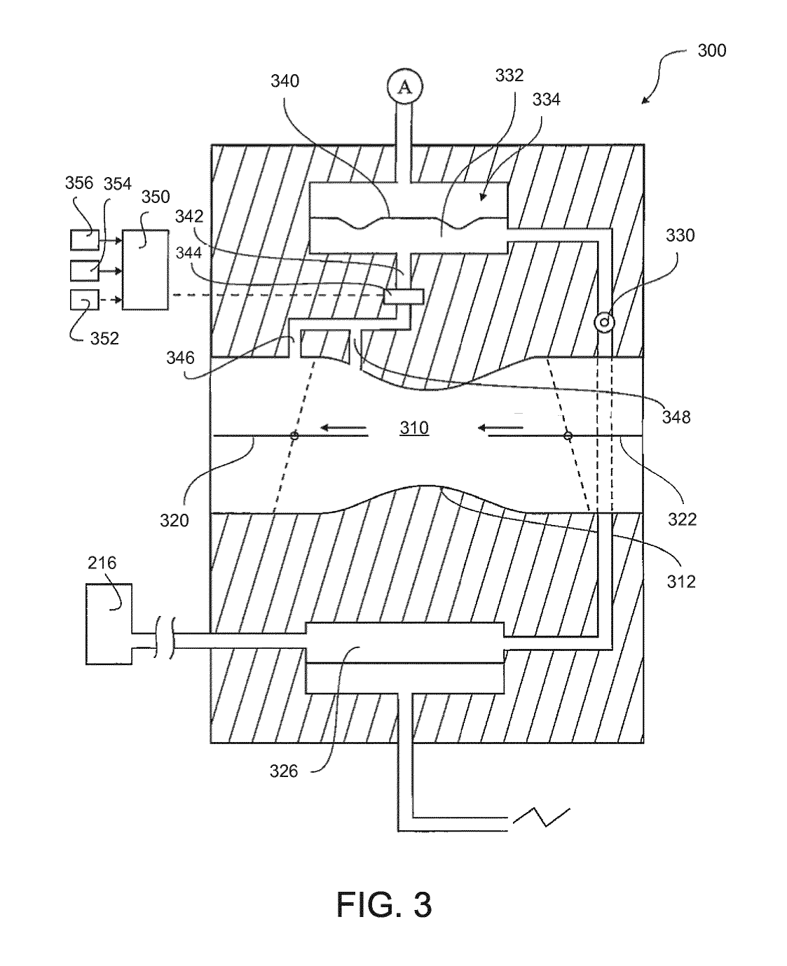

FIG. 3 illustrates a carburetor type fuel supply system 300 in accordance with an example embodiment. As shown in FIG. 3, the carburetor of the fuel supply system 300 includes an intake passage 310 having a venturi 312. The system 300 comprises a throttle valve 320 and a choke valve 322 in the intake passage 310. The carburetor of the fuel supply system 300 also includes a fuel pump 326, which draws fuel from the fuel tank 216. The fuel pump 326 delivers fuel, via a needle valve 330, to a fuel metering chamber 332 of a fuel regulator 334.

The fuel metering chamber 332 may be separated from atmospheric pressure by a diaphragm 340 and may be configured to hold a predetermined amount of fuel. A duct 342 from fuel metering chamber 332 may lead to a fuel valve 344. The fuel valve 344 may be a bistable valve, operating between open and closed positions. The fuel valve 344 may open or close the interconnection between the fuel metering chamber 332 and the fuel lines (346 and 348), leading to the intake passage 310 via respective nozzles.

The fuel valve 344, which may in some cases be solenoid operated, may be controlled by an electronic control unit (ECU) 350 (e.g., a controller). The ECU 350 may also control operation of the spark plug 234 for the application of spark to ignite the mixture 210 in the combustion chamber 232 of FIG. 2. As such, in some embodiments, the ECU 350 may be an ignition control device. ECU 350 may receive sensor inputs such as, for example, throttle position from a throttle position sensor 352 (or sensors), engine speed data from an engine speed sensor 354 (or sensors), and/or inputs from an additional sensor 356 (or sensors). The additional sensor 356 could be a temperature sensor or any other suitable parameter measurement sensor. The ECU 100 may use the sensor inputs to control the A/F ratio by deciding when to open or close the fuel valve 344 and/or to control the timing of application of spark for ignition of the mixture 210 in the combustion chamber 232.

Engine speed data may be obtained via any of a number of different ways. For example, a flywheel that rotates with the same speed as the engine crank may have one or more magnets provided on its periphery. The magnets can be used to provide energy to the ignition system as well as to other electronic components such as the ECU 350, but may also be used for monitoring the engine speed by having the engine speed sensor 354 comprising a stationary detection unit arranged to detect each time the magnet (or magnets) of the flywheel pass the detection unit. The accuracy of the engine speed sensor 354 may be dependent upon the number of magnets on the flywheel and the number of detection units. For example, by using one magnet and one detection unit, the time it takes for a full rotation can be measured, and by using two magnets and one detection unit, the time it takes for a half rotation of the flywheel can be measured. If engine speed is to be measured more frequently, the number of magnets and/or the detection units can be increased. Alternatively or additionally, other methods of providing engine speed data may be employed within the spirit and scope of example embodiments.

As discussed above, for a typical engine, the operator manually positions the choke valve 322 initially to a closed position. This allows the flow of air into the intake passage 310 of the carburetor to be restricted to reduce the pressure in the throat of the carburetor and cause a proportionally greater amount of fuel to be pushed into the combustion chamber 232 during the start process. After the engine starts, the throttle valve 320 may be operated to control engine RPM and the choke valve 322 desirably be in the open position. However, during a typical start process, the operator must select the appropriate time to reposition the choke valve 322 by repositioning the choke lever (e.g., operable member 160) based on hearing the “pop” sound that is indicative of initial ignition. If the proper timing for making this adjustment is missed, the engine may be flooded.

Accordingly, example embodiments may provide for automatic adjustment of the choke valve 322 and the choke lever (e.g., the operable member 160) when indications indicative of initial ignition are detected by other means so that the operator cannot miss the “pop” and fail to properly position the choke lever. This essentially provides for manual initial positioning of the choke valve 322 via operation of the choke lever, but automatic repositioning of the choke valve 322 (and choke lever) when initial ignition is detected. Thus, a semi-automatic starter assembly is provided where the operator manually closes the choked valve 322, but the choke valve 322 is automatically opened after initial ignition is detected (as illustrated in FIG. 3).

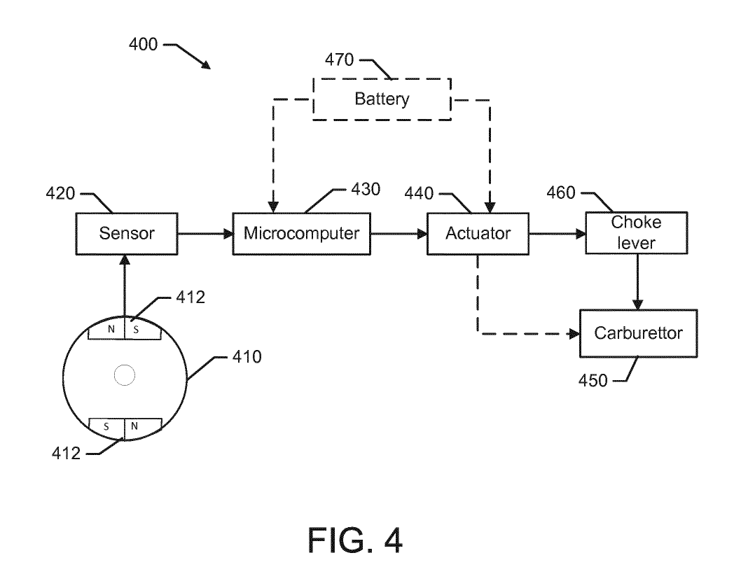

FIG. 4 illustrates a block diagram of various components of a semi-automatic starter assembly 400 in accordance with an example embodiment. The semi-automatic starter assembly 400 may include a flywheel 410 (e.g., the flywheel of the recoil starter 150) or any other rotational starter that is operably coupled to a sensor 420. The sensor 420 may in turn be operably coupled to a microcomputer 430 that is operably coupled to an actuator 440. The microcomputer 430 may be a controller or other processing circuitry (e.g., the ECU 350) in some embodiments. The actuator 440 may be operably coupled (e.g., directly or indirectly) to the carburetor 450 (or 300 as in FIG. 3). For indirect coupling, the actuator 440 may be operably coupled to the choke lever 460 (e.g., an example of the operable member 160) and reposition the choke valve 322 by repositioning the choke lever 460. A battery 470 may optionally be included to power either or both of the actuator 440 and the microcontroller 430. However, in alternative embodiments, either or both of the actuator 440 and the microcontroller 430 could be powered by electrical energy generated based on motion of the flywheel 410 of the engine.

Inside the carburetor 450 (300), the choke valve 322 and the throttle valve 320 may each be attached to corresponding shafts that are operable for controlling valve positions of the choke valve 322 and the throttle valve 320, respectively. The two shafts may be mechanically linked together to achieve fast idle (e.g., when the choke valve 322 (normally open) is closed and the throttle valve (normally closed) is open a few degrees. The shafts may also be manipulated for other operating or starting positions, as appropriate.

The choke lever 460 may be coupled to the shaft to which the choke valve 322 is attached so that repositioning the choke lever 460 correspondingly changes the position of the choke valve 322. In some cases, the choke lever 460 may have a locking assembly disposed thereon, and the locking assembly may be locked in the choke (closed) position, and the choke lever 460 may be unlocked to allow the choke lever 460 to be repositioned automatically to the normal position (in which the choke valve is open). In an example embodiment, the choke lever 460 may be biased to return to the normal (open) position whenever the choke lever 460 is unlocked by a spring that may bias the choke lever 460 to return to the normal position as described in greater detail below.

In an example embodiment, the flywheel 410 may have one or more magnets 412 disposed thereon, and the magnets 412 may spin with the flywheel 410 when the recoil starter 150 is operated. The sensor 420 may be provided to determine the movement of the flywheel 410 (e.g., by detecting movement of the magnets 412). In some cases, the sensor 420 may include one or more Hall Effect sensors positioned proximate to the flywheel 410. The sensor 420 may be the same sensor as the engine speed sensor 354 of FIG. 3, or could be an additional or different sensor in alternative embodiments. The sensor 420 may be operably coupled to the microcomputer 430 (e.g., the ECU 350 or other processing circuitry generally referred to as a “controller”) to provide indications of movement to the microcomputer 430. The microcomputer 430 may receive the indications of movement (e.g., pulses detected responsive to passage of the magnets 412 past the sensor 420) and make determinations or calculations regarding engine parameters or state based on the indications of movement. Thus, for example, the indications of movement may be used to calculate speed, determine RPM, determine engine state, and/or the like. The engine state may be any of a number of different states including, for example, off, running, first ignition, etc. First ignition may be a state determined when indications of initial ignition are determined (i.e., the conditions otherwise correlated with the “pop” sound).

In an example embodiment, the microcomputer 430 may be operably coupled to an actuator 440. The actuator 440 may operate based on a state change from off to first ignition, or simply based on the detection of first ignition. In some cases, the microcomputer 430 may be configured to detect the state change from off to first ignition (or simply first ignition) and provide a signal indicative of the same to the actuator 440. Responsive to the signal (or trigger), the actuator 440 may reposition the choke valve 322 and/or the choke lever 460. In some embodiments, the actuator 440 may be a servo, a solenoid, or other such actuation device that is capable of physically adjusting a position of the choke valve 322 in the carburetor 450, and in some cases also the choke lever 460 responsive to the signal (or trigger) from the microcomputer 430.

The actuator 440 may be initially in an off position or unpowered state (i.e., a normal position) when the first ignition has not been detected, thereby allowing the choke lever 460 to stay in the position in which the choke lever 460 has been manually placed by the operator for starting (e.g., with the choke valve 322 being closed). The actuator 440 may therefore be in the normal position or rest state when the choke lever 460 is in the choke position. Responsive to receipt of the signal (or trigger), the actuator 440 may be transitioned to an on position or powered state in which the choke lever 460 and/or the choke valve 322 are repositioned (e.g., such that the choke valve 322 is opened). In such an example, the shaft upon which the choke valve 322 is mounted may have a spring or other biasing member provided thereon as a choke valve biasing member. The choke valve biasing member may bias the choke valve 322 toward the normal (open) position. Thus, for example, when the choke lever 460 is moved to the choke position, the shaft on which the throttle valve 460 is mounted may be rotated to coil and charge the choke valve biasing member as the choke valve 322 is moved (and held) in the closed position. When the actuator 440 operates, the holding of the choke valve 322 (and its shaft) may be released so that the choke valve biasing member returns the choke valve 322 to the normal (open) position while the rotation of the shaft also repositions the choke lever 460 to its normal position. Thus, the actuator 440 may operate to release the choke lever 460. However, it should be appreciated that the states of the actuator 440 could be reversed in some embodiments.

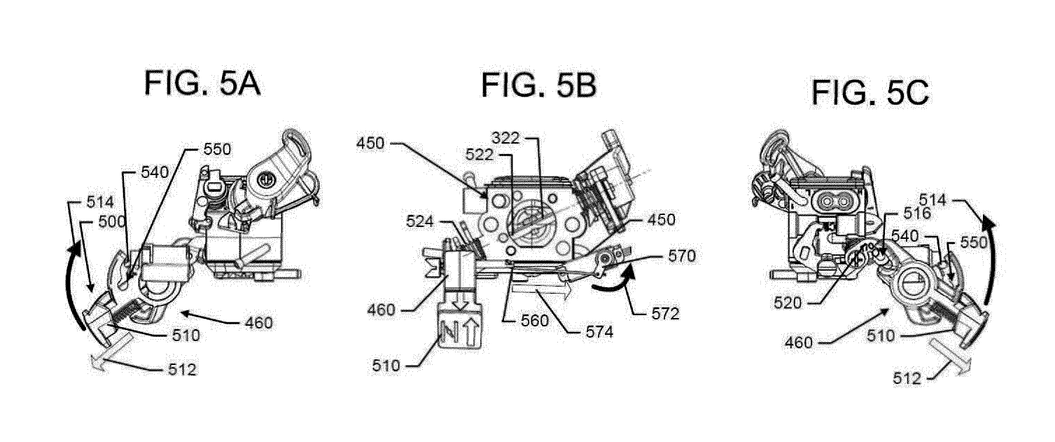

FIG. 5, which includes FIGS. 5A, 5B and 5C, shows various views of some of the components of a semi-automatic starter assembly as such components would appear in isolation if viewed from corresponding sides of the chainsaw in which the assembly is instantiated in accordance with an example embodiment. In this regard, FIG. 5A is a right side view of the assembly in isolation. FIG. 5B is a rear view of the assembly, and FIG. 5C is a left side view of the assembly in isolation. In the example of FIG. 5, the choke lever 460 is directly coupled to the actuator 440. However, alternative structures may be provided in some cases. Thus, the physical structures shown in FIG. 5 should be appreciated as merely illustrative of one way to embody an example embodiment.

As shown in FIG. 5, the choke lever 460 may have a lock assembly 500 that can have a first locking portion to allow a cap portion 510 of the choke lever 460 to be withdrawn in the direction shown by arrow 512 to unlock the cap portion 510 and allow the choke lever 460 to be rotated in the direction of arrow 514 toward the choke position. When the choke lever 460 is rotated toward the choke position, an engagement slot 516 of the choke lever 460 engages a choke arm 520 that is operably coupled to the shaft 522 on which the choke valve 322 is disposed. The choke arm 520 is rotated to correspondingly rotate the shaft 522 and move the choke valve 322 to the choke position against the biasing force of the choke valve biasing member (spring 524), which is coiled around a portion of the shaft 522 and/or the choke arm 520. The spring 524 therefore biases the choke valve 322 toward the normal (open) position and will tend to return the choke valve 322 to the normal (open) position when the choke arm 520 and/or the shaft 522 are no longer held in the choke position. Thus, the fixed positions of the choke valve 322 (open or closed) are held by the choke lever 460 in this example.

Using the structure of FIG. 5, the positions of the choke valve 322 are not controlled by the carburetor 450. Instead, the choke valve 322 is only on (e.g., in the choke position) when held in such position by the choke lever 460. Repositioning the choke lever 460, or allowing the spring 524 to reposition the choke lever 460, will return the choke valve 322 to the normal (open) position. In an example embodiment, the lock assembly 500 may employ a second locking portion to allow the choke lever 460 to be held in the choke position until it is manually moved by the operator, or by the actuator 440. The second locking portion may include a locking pin 540 and a locking slot 550. The locking slot 550 may be provided at a portion of the choke lever 460, and the locking pin 540 may be operably coupled to the actuator 440 via a link 560. The locking pin 540 may engage a portion of the locking slot 550 to hold the choke lever 460 in the choke position after manual positioning of the choke lever 460 in the choke position. However, when the actuator 440 is triggered, the actuator 440 may alter the position of the locking pin 540 relative to the locking slot 550 (e.g., by removing the locking pin 540 from the locking slot 550) to release the lock on the choke lever 460 so that the spring 524 returns the choke lever 460 to the normal (open) position. In an example embodiment, the actuator 440 may rotate a lever arm 570 in the direction of arrow 572 when triggered to pull the link 560 in the direction of arrow 574 and release the lock on the choke lever 460.

In an example embodiment, the actuator 440 may be actuated responsive to the control signal (or trigger) from the microcomputer 430. The receipt of the control signal (or trigger) may be experienced as a trigger event. In particular, the control signal (or trigger) may be an indication of the first ignition as described above. As such, the microcomputer 430 may be configured to initiate automatic repositioning of the choke valve 322 from the choke position to the normal (open) position based on detection of the control signal or trigger event associated with the movement parameters detected by the sensor 420. In some cases, the movement parameters may include indications of speed of a flywheel of the engine. The trigger event may be detected responsive to the speed reaching a predetermined level, the acceleration change reaching a predetermined level an indication of movement being received within a predetermined time after the engine was in a run state, or the speed exceeding a maximum RPM level for a single pull of the recoil starter. Thus, the trigger event may essentially correspond to an indication of the optimal conditions for an engine start. The optimal conditions for an engine start may be determined by comparing processed information with preset data. Thus, for example, the optimal conditions may be detected when the calculated/processed air-fuel ratio associated with the detected movement parameters achieve a preset optimal air-fuel ratio for ignition. The preset data may be recorded in the microcomputer 430 (e.g., the ECU 350). Moreover, processed information such as running data, engine parameters and/or engine status information may be logged or recorded in the microcomputer 430 to allow the in the microcomputer 430 to compare the processed information to the preset data on a real time basis. The comparison may be used to make decisions about whether to trigger the actuator 440 when optimal conditions for engine start are detected based on the trigger events described above. In other words, indications that first ignition has occurred, and therefore that the optimal conditions for start are present may be used to trigger actuation of the actuator 440 and automatic repositioning of the choke lever 460 (and thereby also the choke valve 322).

In some embodiments, at least one of the controller or the actuator may be powered responsive to motion of the flywheel of the engine or may be battery powered. In an example embodiment, the engine includes a flywheel having at least one magnet attached thereto, and the sensor is disposed to detect the movement parameters based on detection of movement of the at least one magnet. The sensor may include, for example, a Hall Effect sensor. In some cases, the controller may be programmed to determine an engine start ignition condition (e.g., the optimal air-fuel ratio and/or the indication of a first start ignition) based on the movement parameters. In an example embodiment, the system may further include a choke lever biased to position the choke valve in the open position and locked to position the choke valve in the choke position. In such an example, the actuator may be actuated to unlock and release the choke lever. In some cases, the actuator may be operably coupled to a locking portion of the choke lever via a link. The link may be moveable based on a state of the actuator to alternately hold the choke lever such that the choke valve is in the choke position and release the choke lever to return the choke valve to the open position. In an example embodiment, a spring may be operably coupled to a shaft on which the choke valve is mounted, and the spring may provide a biasing force to move the choke valve to the open position when the choke lever is released.

Some example embodiments may reduce the number of starting steps for engine start, and may essentially eliminate any need to have a different procedure between cold start or warm start. In this regard, the choke will be handled appropriately in either case without any need to detect temperature by automatic deactivation of the choke. Some example embodiments may allow a relatively simple type of processing to be employed to govern starting conditions so that temperatures sensors and processing based on temperature conditions may not be necessary. Thus, simpler, cheaper and still effective control of hand held outdoor power equipment may be achieved to provide superior starting characteristics in all environments and situations. Some example embodiments may also include a method for upgrading or otherwise modifying an existing hand held power tool (e.g., a chainsaw) by providing a module or upgrade kit including components of the semi-automatic starter assembly 400 described herein. In particular, the method may include at least providing an actuator 440 for automatic repositioning of the choke valve 322 in the semi-automatic starter assembly 400.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

1. A starter system for an internal combustion engine, the engine comprising:
a carburetor having at least a choke valve for controlling a flow of a fresh air into a combustion chamber of the engine during engine start, the choke valve having a choke position and an open position, the choke valve being positioned into a choke position at engine start, and
a recoil starter for starting a rotation of an engine crankshaft causing a fuel supply to the combustion chamber of the engine, the starter system comprising:
a sensor disposed to detect movement parameters associated with the engine or crankshaft responsive to operation of the recoil starter;
a controller operably coupled to the sensor to receive information indicative of the movement parameters and providing a control signal based on processed information providing an indication of an optimal condition for engine start, and
an actuator configured to receive the control signal from the controller,
wherein the actuator is configured to initiate automatic repositioning of the choke valve from the choke position to the open position based on receiving of the control signal from the controller responsive to the indication of the optimal condition for engine start.

2. The starter system of claim 1, wherein the movement parameters comprise indications of one of:
a speed of a flywheel of the engine,
an acceleration change of the flywheel,
an indication of movement of the flywheel within a predetermined time after the engine was in a run state, and
an indication of speed of the flywheel exceeding a maximum revolutions per minute level for a single pull of the recoil starter.

3. The starter system of claim 1, wherein at least one of the controller or the actuator is powered responsive to motion of the flywheel of the engine.

4. The starter system of claim 1, wherein at least one of the controller or the actuator is battery powered.

5. The starter system of claim 1, wherein the engine includes a flywheel having at least one magnet attached thereto, and wherein the sensor is disposed to detect the movement parameters based on detection of movement of the at least one magnet.

6. The starter system of claim 1, wherein the controller is programmed to determine an engine start ignition condition based on the movement parameters.

7. The starter system of claim 1, wherein the sensor comprises a Hall Effect sensor.

8. The starter system of claim 1, further comprising a choke lever biased to position the choke valve in the open position and locked to position the choke valve in the choke position, and wherein the actuator is actuated to unlock and release the choke lever.

9. The starter system of claim 8, wherein the actuator is operably coupled to a locking portion of the choke lever via a link, the link being moveable based on a state of the actuator to alternately hold the choke lever such that the choke valve is in the choke position and release the choke lever to return the choke valve to the open position.

10. The starter system of claim 9, further comprising a spring operably coupled to a shaft on which the choke valve is mounted, the spring providing a biasing force to move the choke valve to the open position when the choke lever is released.

11. A two stroke internal combustion engine comprising the starter system of claim 1.

12. A device motorized by the two stroke internal combustion engine of claim 11.

13. A handheld power tool provided with an internal combustion engine and the starter system of claim 1.

14. A chainsaw comprising the starter system of claim 1.

15. A method of upgrading or modifying a hand held power tool, the method comprising providing an actuator for automatic repositioning of the choke valve in the starter system of claim 1.
